(19) United States
(12) Patent Application Publication
(10) Pub. No.: US 2014/0258299 A1
(43) Pub. Date: Sep. 11, 2014

(54) Method for Assigning Similarity-Based Codes to Life Form and Other Organisms

(71) Applicant: Boris A. Vinatzer, Blacksburg, VA (US)

(72) Inventor: Boris A. Vinatzer, Blacksburg, VA (US)

(21) Appl. No.: 14/199,441

(22) Filed: Mar. 6, 2014

Related U.S. Application Data
(60) Provisional application No. 61/774,030, filed on Mar. 7, 2013.

(51) Int. Cl. G06F 19/28

(52) U.S. Cl. CPC G06F 19/28
USPC 707/737

(57) ABSTRACT

A system and method for assigning a classification code, name or identification number to a life form. The classification code is based on the similarity of a nucleic acid sequence of a life form to another life form. The classification code has a plurality of predetermined positions with each position corresponding to a threshold level of nucleic acid similarity to a reference life form having a nucleic acid sequence.

### CROSS-REFERENCE TO RELATED APPLICATIONS

This application claims the benefit U.S. Provisional Application No. 61/774,030, filed Mar. 7, 2013 and herein incorporated by reference.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Field of the Invention

A classification and naming system for life on earth is a useful tool for biological research and development. This is one of the reasons why Carl Linnaeus' hierarchical classification and naming system has been widely used. The Darwinian concept of common descent and the advent of DNA sequencing have substantially changed biology over time and brought concomitant adjustments to the original Linnean classification system. However, science is facing yet another challenge in biological classification. The revolution in DNA sequencing technology now allows the sequencing of genomes of any size at low cost and is revealing a level of genetic diversity that cannot be classified and named appropriately within the current biological classification system.

Limitations of the current biological classification and nomenclature system are manifold. First, belonging to the same species is poorly predictive of similarity between individuals. Since the early development of biological classification, the species has been the most important unit. However, there is still no agreement about the definition of species, in particular, in regard to bacterial species. Therefore, different species are characterized by very different degrees of similarity of the organisms that they encompass. For example, organisms belonging to one species may all be derived from a very recent ancestor and be genetically and phenotypically extremely similar to one another. On the other hand, organisms belonging to another species may be derived from a more distant ancestor and be genetically and phenotypically much more different from each other. Therefore, belonging to the same species is generally a predictor of common ancestry, but not a predictor of how similar organisms of the same species are to one another.

Moreover, there is no general system for classification within species. Today almost any individual bacterial or fungal isolate or plant or animal can be distinguished from any other individual using DNA sequencing. Based on partial or complete genome sequences, organisms can then be assigned to classes within the species. However, there is no general system to define intraspecific classes based on DNA similarity and there are no general rules to name such classes, making it impossible to take full advantage of genome sequencing for classification within a species.

Multilocus sequence typing (MLST) has emerged as a solution by assigning bacteria to genetic lineages, called sequence types (STs), which have identical alleles at a small number of genomic loci. However, MLST presents several limitations of its own: (i) since only six to eight genomic loci are typically used, each ST still includes isolates with a considerable amount of genetic diversity that is not classified; (ii) since different MLST schemes use different loci, MLST schemes have different resolutions leading to STs of different genetic diversity; (iii) ST names do not provide any information about the relationship between STs (bacteria belonging to two different STs may be very closely related or only distantly related); and (iv) MLST is not hierarchical, providing only one level of resolution (diversity within a single ST or similarity between STs is not considered). Ribosomal MLST (rMLST) is based on 53 genes coding for the same ribosomal proteins present in almost all bacteria and alleviates. However, even rMLST possesses shortcomings such as: (i) it is not hierarchical; (ii) resolution is limited by using a restricted set of loci instead of whole genomes; and (iii) rMLST ST numbers are not informative of the relationships among different STs.

Besides MLST, other classification systems have been developed for other specific groups of organisms. For example, for many viral species, numbers are assigned to different intraspecific sub-groups, and, in human genetics, a system for classification of mitochondrial genomes has been devised that assigns individuals to mitochondrial haplogroups based on polymorphic regions in mitochondrial genome. Although different intraspecific classification systems are relatively useful for scientists working with specific species, they present a series of weaknesses: they each have a different resolution, they each use different methods to assign individuals to classes, and they each use different naming conventions. Therefore, current intraspecies classification systems represent high barriers to communication about intraspecific diversity and hinder understanding of intraspecific diversity.

Besides MLST, other classification systems have been developed for other specific groups of organisms. For example, for many viral species, numbers are assigned to different intraspecific sub-groups, and, in human genetics, a system for classification of mitochondrial genomes has been devised that assigns individuals to mitochondrial haplogroups based on polymorphic regions in mitochondrial genomes. Although these different intraspecific classification systems are relatively useful for scientists working with specific species, they present a series of weaknesses: they each have a different resolution, they each use different methods to assign individuals to classes, and they each use different naming conventions. Therefore, current intraspecies classification systems represent high barriers to communication about intraspecific diversity and hinder understanding of intraspecific diversity.

In addition, species descriptions and names are unstable. Lastly, species descriptions change with discovery of new diversity and/or identification of additional genetic or phenotypic characterization of organisms belonging to a species. This leads to recurrent revisions of species descriptions, which may cause individual taxa to be assigned to different species changing the species name that is used to refer to them. This is especially true for bacteria, but also for animals and plants for which revisions are regularly published in systematics journals. Moreover, an extensive revision of fungal species names is currently under way, transitioning from naming pleomorphic fungi with two separate names to using single names. Although the end result of this revision can be expected to significantly reduce confusion in fungal taxonomy, in the short term, these changes will create more confusion. Importantly, changes in species descriptions and/or names not only represent a challenge for researchers, they can have dangerous implications for medical diagnostics when they concern pathogenic organisms. Such changes in species descriptions can lead to miscommunication between medical personnel about the identity of pathogens, thereby compromising the application of the most appropriate treatment.

### BRIEF SUMMARY OF THE INVENTION

The present invention addresses the above problems by providing a genome-based classification and naming system to complement the current biological classification system. The system consists of codes that are assigned to each individual genome-sequenced organism. Code assignment is based on the measured similarity of an organism's genome to the genome of the most similar organism that already has a code at the time.

In accordance with one embodiment, a system for assigning codes to genomes comprises a computational system. The system, in one embodiment, assigns a new code to a genome based on genome or nucleic acid sequence similarity to already coded genomes as a hierarchical string of non-negative numbers.

The present invention allows codes to be assigned as soon as the genome of the organism is sequenced independently of any lengthy phylogenetic or phenotypic analysis. Codes may be permanent and need not be revised when codes are assigned to additional related organisms. Codes can be assigned to all life forms including viruses, bacteria, fungi, plants, and animals, hence providing a standardized, uniform naming system for all life on earth. Organisms with similar genomes will have similar codes based on the degree of similarity—in fact, a code prefix provides an alternative, hierarchical kind of organization of genomes.

In a preferred embodiment, the present invention assigns a classification code, name or identification number to any individual life form including but not limited to any virus, bacterium, fungus, plant, animal, and human being and to any mutated tissue or cell that is part of any such life form. The classification code being based on the similarity of a nucleic acid sequence of said individual life form to another life form including but not limited to a partial, draft, or complete genome sequence. The classification code has a plurality of predetermined positions with each position corresponding to a threshold level of nucleic acid similarity to a reference life form that has a nucleic acid sequence.

The method used by an embodiment of the invention to create a classification code comprises selecting from a nucleic acid database a nucleic acid sequence of a reference life form having a code having a plurality of predetermined positions. A determination is made as to the similarity between the nucleic acid sequence of the individual life form and the nucleic acid sequence of the reference life form. A code for the individual life form is created. The code has a plurality of predetermined positions equal to the number of the plurality of predetermined positions of the reference life form.

Code assignment is performed by the following steps: for each individual predetermined position of the code of the life form, assign the same code value which can be a number, letter, or symbol used in the individual position of the code of the reference life form when the similarity between the two nucleic acid sequences of the two said life forms is equal to or higher or greater than the degree of similarity at a threshold level of nucleic acid similarity of said predetermined position; repeating the above step until reaching an end or cutoff position in the code for which the similarity between said nucleic acid sequence of said life form and said reference nucleic acid sequence of said reference life form is lower than the threshold level of nucleic acid similarity at the cutoff or end position; and at the cutoff or end position assigning a different code value to that position.

In another embodiment, for the code of the first life form, a default value, which can be a number, letter, or symbol, is used at each predetermined position of the code assigned. In addition, for each code position after the cutoff or end position, the default value for each individual position is assigned. Lastly, at the cutoff or end position of the code, the code value assigned to the individual life form is unique in that it is different from the code value at said position compared to all other life forms that have already been assigned a classification code.

### BRIEF DESCRIPTION OF THE SEVERAL VIEWS OF THE DRAWINGS

FIG. 1 shows details of one embodiment of the system as a computational hardware system.

FIG. 2 shows the processing done on a newly available genome sequence in one embodiment of the system.

FIG. 3 shows one embodiment of threshold levels that may be used with an embodiment of the invention.

FIG. 4 shows exemplary codes having fourteen predetermined positions.

FIGS. 5A-5D provide an overview of genome similarity-based code assignment.

FIG. 6 illustrates applications for genome similarity-based codes.

### DETAILED DESCRIPTION OF THE INVENTION

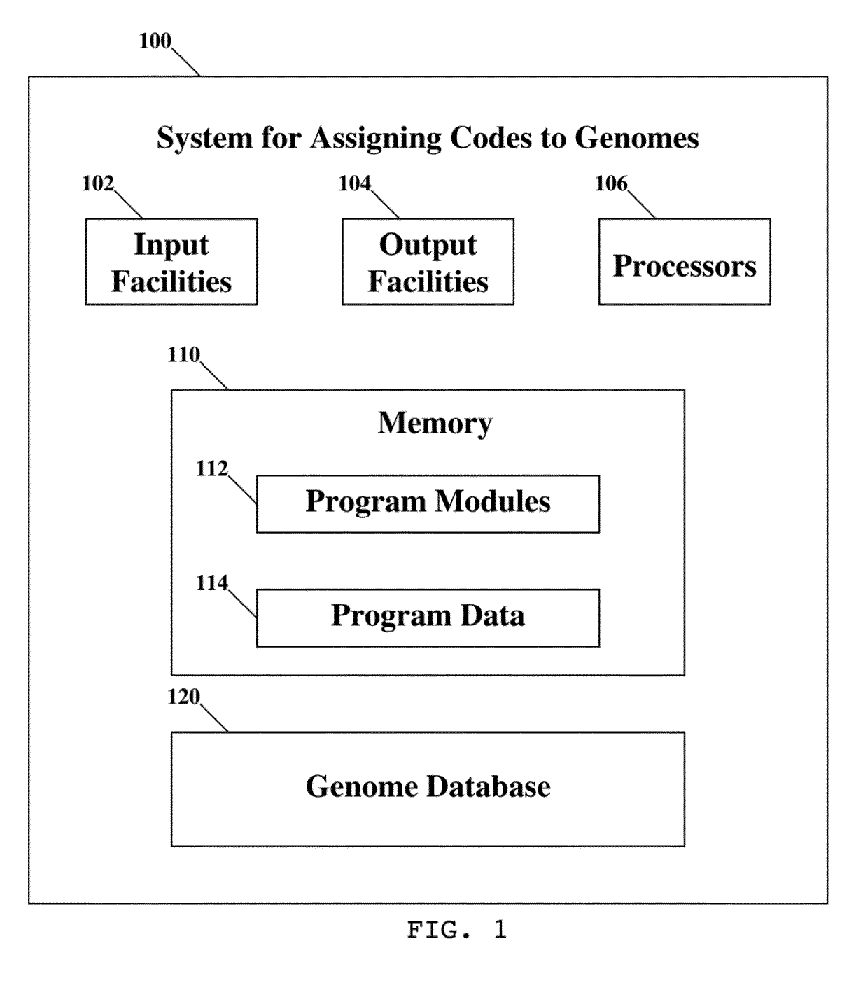

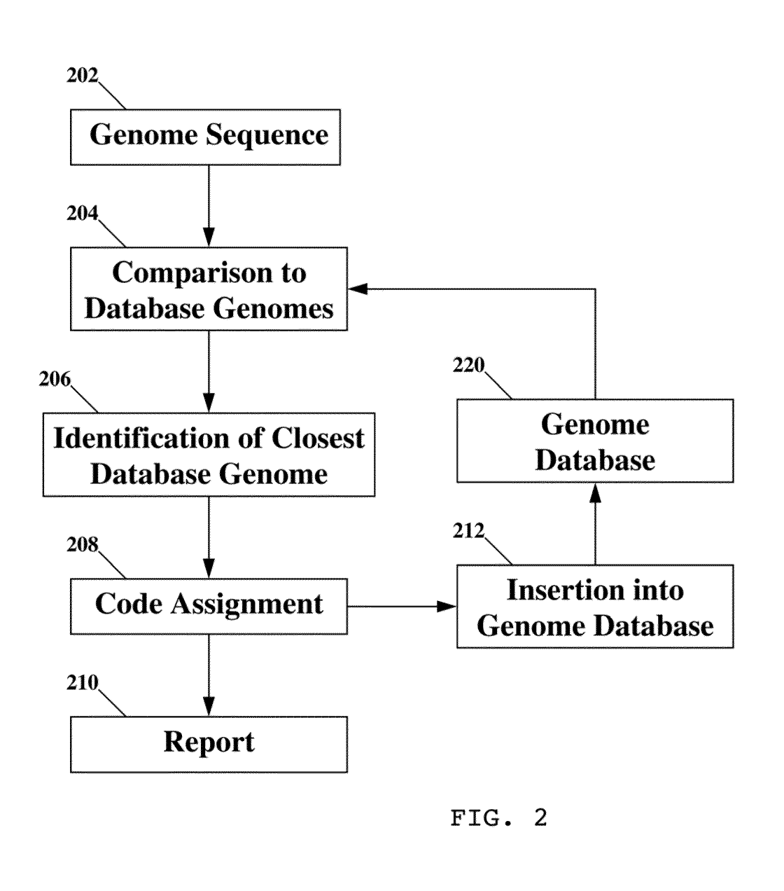

This description is not to be taken in a limiting sense, but is made merely for the purpose of illustrating the general principles of the invention. The scope of the invention is defined by the appended claims. In a preferred embodiment, the present invention includes, as illustrated in FIGS. 1 and 2, a computational hardware system 100 for assigning codes to genomes including input facilities 102, output facilities 104, processors 106, a memory 110, and a genome database 120.

The input facilities 102 are required to accept commands to the system, as well as sequenced genomes. They may consist of a variety of components such as personal computers, workstations, cell phones, computational tablets, networks, terminals, or web pages connected to web servers. The output facilities 104 deliver reports to users or to external systems such as web servers or communication networks. They may consist of a variety of components such as networks, printers, cell phones, computational tablets, or any computer display.

The processors 106 consist of one or more processing units in any configuration, including single core, multicore, graphical processing unit, dedicated processor assistant, field programmable gate array (FPGA), distributed, and parallel. The memory 110 is required to store the program modules 112 and program data 114 used for the processing in FIG. 2 that assigns codes to sequenced genomes. The memory 110 may consist of a variety of memory technologies, not limited to random access memory, cache, or hardware registers. The program modules 112 consist of instructions in some programming language to direct the processing shown in FIG. 2 and may consist of hardware executable instructions or source code interpreted by a hardware or software interpreter. The program data 114 consist of all genome or nucleic acid sequences and other values required by the program modules 112 to accomplish the process in FIG. 2.

The genome database 120 is a relational or other technology database containing nucleic acid or genome sequences, their assigned codes, and any associated metadata such as species identification (if known), who sequenced the genome, and relevant dates. The genome database 120 can be stored in a variety of technologies, including hard disk drives, solid state disk drives, solid state memory, distributed storage units, network-based storage, or computational cloud storage.

The processing accomplished in FIG. 2 is shown as a set of interrelated steps. The steps are accomplished under the control of the processors 106 as directed by the program modules 112. The genome sequence 202 consists of a partially or totally sequenced genome or of a partially or totally assembled genome of any life form or other organism. It can be presented to the input facilities 102 in any established or defined sequence format, including FASTA and FASTQ.

The genome database 220 is identical to the genome database 120. It consists of a plurality of m sequenced genomes G[1], G[2], . . . , G[m], each of which has already been assigned a code. An infinite number of potential code systems are possible, with each individual code system controlled by particular parameters. The extent c of a code system is one parameter that defines the number of nonnegative integers required to specify the code of a sequenced genome. The remaining parameters of a code system are e percentage thresholds t[1], t[2], . . . , t[e], which specify thresholds of similarity for use in code assignment. The thresholds are chosen so that 0<t[1]<t[2]< . . . <t[e]<100. For example, a particular code system is determined by the parameters e=5, t[1]=20, t[2]=40, t[3]=60, t[4]=80, and t[5]=90. An actual code in a code system is a sequence of e nonnegative integers, which may conveniently be separated by periods, so a code has the form n[1].n[2].n[3] . . . n[e]. For the example, 57.122.3.0.19 is a legal code, as is 0.0.0.0.0. Every one of the m genomes in the genome database 220 has a unique code from the chosen code system. For convenience, the first genome inserted in the genome database 220 has code n[1].n[2].n[3] . . . n[e]=0.0.0 . . . 0.

The comparison to database genomes 204 consists of an iteration through the genome database 220 to compare genome sequence 202 to every genome G[1], G[2], . . . G[m]. The comparison can be accomplished according to any similarity scheme that returns a percentage similarity between 0 and 100. Such methods have already been developed and are being used to calculate average nucleotide identity (ANI) values to assign bacteria to named species. An algorithm for performing ANI calculations may be BLAST and others may be used as well. BLAST is particularly suitable for comparing distantly related genome. Therefore, ANIb (ANI calculated using BLAST) is a good method of computing percentage similarity, among others. Percentage similarity computation can also be accomplished using any kind of distance measure between genome sequences, subsequently converted to a percentage similarity between 0 and 100 by any means.

Assigning a classification code to an organism may be accomplished by first selecting from a genomic database a genome having the greatest similarity to a genome in the database sequence 202. That genome, call it G[k], and its similarity to the genome sequence 202, call it p, are recorded. The code assignment 208 depends on p and the code assigned to G[k], call it n[1].n[2].n[3] . . . . n[e]. The similarity p equals or exceeds some of the thresholds 0, t[1], t[2], . . . , t[e], 100. If 0<=p<t[1], then the genomes have little or no similarity. In that case, the smallest integer m that has not been used in the first position of any existing code is computed, and the genome sequence 202 is assigned the new code m.0.0.0 . . . 0, which essentially starts a new high level code. If p=100, then the genome sequence is identical to G[k] and receives the same code. Otherwise, there is an i such that t[i]<=p and p is less than the next threshold. In that case, the smallest integer in that has not been used in the ith position of any existing code that starts n[1].n[2] . . . n[i−1] is computed, and the genome sequence 202 is assigned the new code n[1].n[2] . . . n[i−1].m.0.0 . . . 0. Continuing the previous example, if 57.122.3.0.19 is the code for G[k] and p=50, then i=2. If the smallest integer not yet assigned to position 2 in codes that start with 57 is m=197, then genome sequence 202 is assigned code 57.197.0.0.0.

Report 210 consists of the use of output facilities 104 to inform the user or another system of the assigned code. Insertion in the genome database 212 consists of inserting the genome sequence 202, along with its assigned code from 208 and additional information, into genome database 220 using standard database operations.

In one embodiment in which processing capacity may be conserved when a new genome needs to be assigned a code, ANI will not need to be calculated against all genomes that already have a code. Instead, the group of genomes that is most similar to the new genome can be identified, for example, using only a few genes, and then ANI is calculated only against the most similar genomes to precisely identify the most similar genome and the corresponding ANI value. Additional processing speeds may be achieved by distributed or parallel computation, where numerous processors 106 are applied to the comparison to database genomes 204.

BLAST is not required to compute percentage similarity, as other methods based on gene content or nucleotide tuple content can be employed to compute or approximate percentage similarity. In addition, a more rapid process can be obtained by using faster approximations to identify the region of the codes that contain the closest database genome, after which a more precise computation of percentage similarity can be employed for the final determination of the closest database genome. Codes need not be based solely on sequences of nonnegative integers. Codes can be based on sequences of characters from any character set as well. The code assignment 208 can be thought of as creating a hierarchy or tree of codes, which can be used for additional applications, including the identification of code clades closely related genomes by percentage similarity.

The present invention assigns a unique and permanent code to all nucleic acid or genome sequenced life forms or organisms, at the level of individual life form or organisms. It also assigns similar codes to organisms with similar sequenced genomes. Codes may also be assigned to organisms of all kinds, including viruses, bacteria, fungi, animals, and plants without expensive or elaborate phylogenetic analysis. By selecting a large extent and appropriately finely spaced threshold parameters, the present invention may assign codes that discriminate with arbitrary precision between similar sequenced genomes.

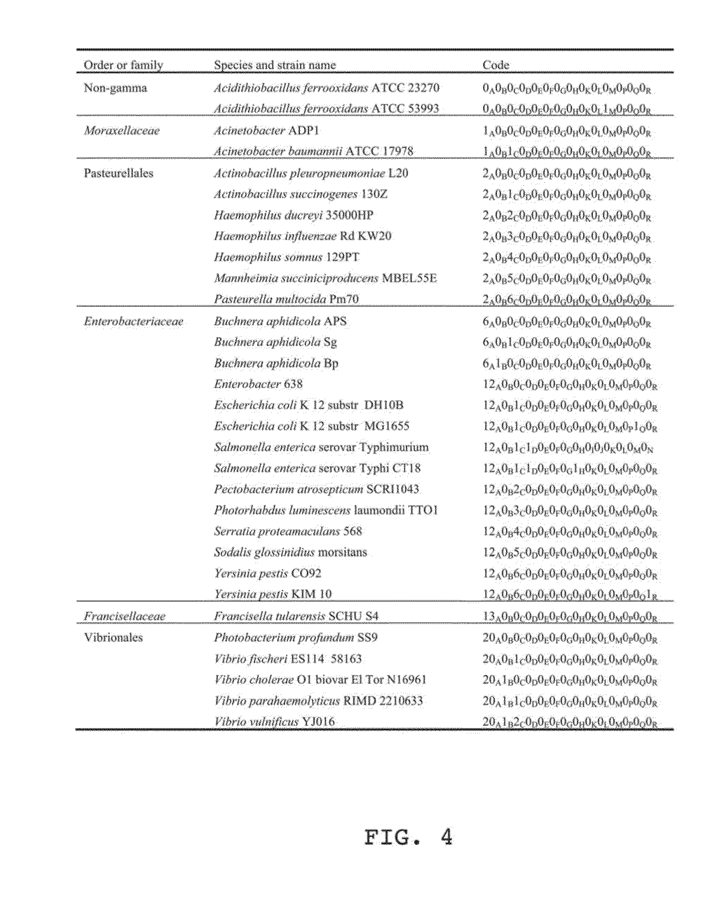

In another embodiment, thresholds for codes consisting of 24 predetermined positions are shown in FIG. 4. Each of the predetermined positions reflects a different level of similarity between life forms or organisms—measured as percentage of DNA identity. The first code position (identified as A) reflects the lowest level of similarity and the last code position (identified as X) reflects the highest level of similarity. Each position in the code indicates a “bin” similar to an operational taxonomic unit whereby the bin size decreases moving from the left to the right of the code.

As shown, the intervals between the percentage-of-similarity-thresholds of adjacent positions decrease from the left to the right of the code. However, a reverse order may be used as well. Using a hierarchical arrangement of thresholds provides a high-resolution of classification and naming system for organisms that are very similar to each other.

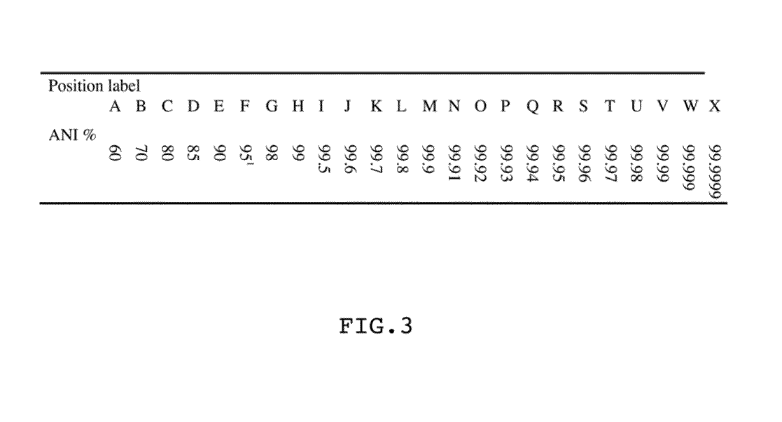

Implementing the thresholds shown in FIG. 3 to create a corresponding code may be accomplished as follows. First, the value “0” was assigned as a default value to the first genome in alphabetical order at all positions of the code (y_{A}, y_{B}, y_{C}, y_{D}, . . . , y_{X}; where each “y” stands for “position” and each subscript corresponds to one of the 24 levels of similarity. To all other genomes, a code will be assigned one by one based on the most similar genome of all the genomes that were already assigned a code. If the percentage of aligned fragments was higher, the following if statement may be executed for each threshold (x_{A}, x_{B}, x_{C}, x_{D}, . . . , x_{X}) and position in the code (y_{A}, y_{B}, y_{C}, y_{D}, . . . , y_{X}): if ANI is higher than cutoff x at position y, then assign the same number as the most similar genome in position y, else assign next higher number to position y and 0 to all following positions. On the other hand, if the “percentage of aligned fragments” value was lower than the threshold, the genome was simply assigned the next higher number at the first position and 0 at all consecutive positions.

Therefore, two organisms or life forms with very similar genomes only differ at position X in their codes. Conversely, very different genomes differ already at position A of their codes, while two organisms with intermediate similarity will be identical to each other at several left-most positions and be different at one of the central positions of the code. Importantly, the actual numeric value at a position does not express similarity. For example, two organisms with a “3” and “4” at one position are not necessarily more similar to each other than two organisms with a “10” and “100” at that position. The information content of genome codes consists in the extent of shared code positions: the more similar the genomes of two organisms are, the further to the right the values at their code positions will be identical.

In a preferred embodiment similarity thresholds need to be used at each position of the code in order for codes to reflect biologically relevant relationships between organisms at different levels of similarity: from the family to the genus and species level all the way to relationships between individual organisms. The challenge is that the range of genome similarity values among organisms is very different depending on their evolutionary history. Therefore, codes need to be composed of a large number of positions that reflect many different similarity thresholds. This leads to impractically long codes. However, a simple solution to this problem is to assign codes with a large number of positions but to use only a subset of the positions depending on the group of organisms that is being described. The present invention does this by labeling each position in the code with a different subscript.

For example, the percentage DNA identity threshold of the last position shared between genome codes of two organisms would not correspond exactly to the percentage of DNA identity between the two organisms' genomes. In fact, two organisms that share the same code up to a certain position, for example position F corresponding to 99% similarity, might actually be slightly less identical to each other than 99%. The reason is that sharing the same code up to position 11 in the proposed system would mean that for each of the two organisms there is at least one other organism that is at least 99% identical and that has the same code at position H. For example, if two organisms are between 98% and 99% identical to each other but more than 99% identical to a third organism, then they would have the same code up to position H if they were assigned their codes after the third organism was assigned its code. However, they would have the same code up to position G if they were assigned codes before the third organism was assigned its code.

The order of code assignment can slightly change the similarity of codes between organisms as shown in FIG. 4, which shows assigned provisional codes to a group of γproteobacteria and a small group of non-γproteobacteria. In this example, code assignment was done in alphabetical order. FIG. 4 shows that the assigned codes correlate well with known taxonomic groups. For example, as shown, all Enterobacteriaceae share the same code up to position B (corresponding to the 70% threshold) besides the divergent Buchnera species characterized by a very reduced genome size. The closely related genera Escherichia and Salmonella share the same code up to position C (corresponding to the 80% threshold); and (iii) the two Escherichia coli strains share the same code up to position M (corresponding to the 99.9% threshold). Therefore, not only do the assigned codes, as shown, correlate well with the named genera and species within the Enterobacteriaceae, but they also provide additional information about similarity that is not obvious from the named taxonomic groups. For example, the codes show that bacteria belonging to the genera Salmonella and Escherichia are closely related, while the genus names do not. Different families within the γproteobacteria do not share any position in their codes since their genome sequences have diverged to a point that they do not align sufficiently for meaningful code assignment using ANIb.

In the above example, the first organism may be assigned “0” at all positions. However, for permanent code assignment the genomes of all organisms would be submitted to the same database and assigned the next available code independently of their current classification.

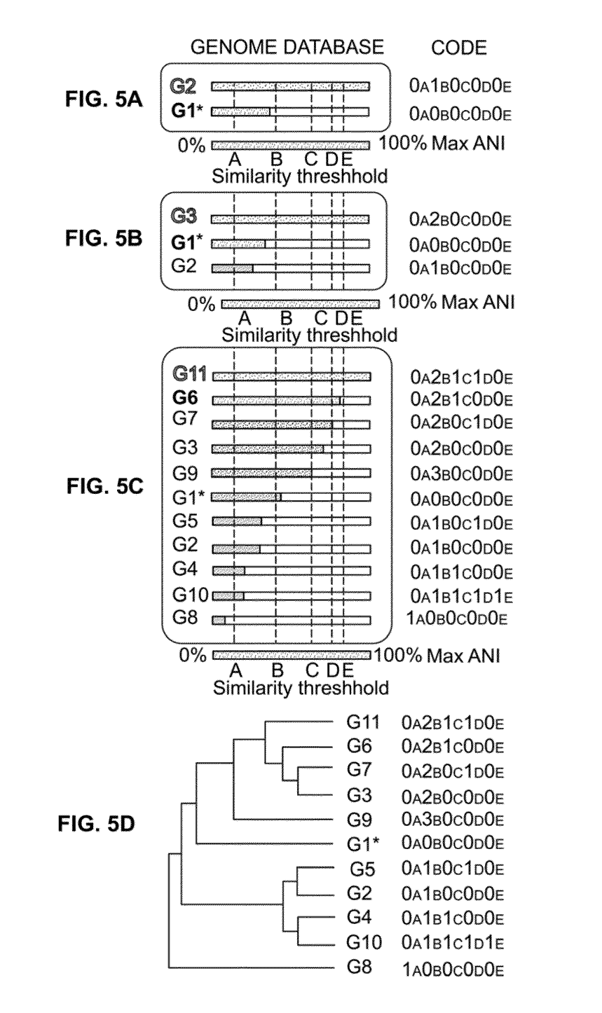

FIGS. 5A-5B show another embodiment of the invention using five code positions. However, as stated above, any desired number of positions may be used. As shown in FIG. 5A, the genome of one organism is chosen as a first or reference genome (G1), added to the genome database, and “0” is assigned to all positions in the code as a default value. A second genome (G2) is then added to the database and compared to G1. A code is assigned to the organism with genome G2 based on the genome similarity to G1 measured as percentage of average nucleotide identity (ANI).

FIG. 5B shows that the genome of a third organism (G3) is compared to G1 and G2, which may be candidates to act as the reference genome. Since G3 is more similar to G1 than G2, G1 is selected as the reference genome. Accordingly, G3 is assigned its code based on its ANI similarity with G1.

As shown in FIG. 5C, every new genome that is added to the database will be compared to all genomes already in the database and codes will always be assigned based on the ANI with the most similar genome, the reference genome. As shown in FIG. 5D, since every organism in the database was assigned a code based on genome similarity with the most similar organism already in the database at the time of its addition, all codes reflect the similarity of organisms with each other, as long as their genomes aligned, and thus are an approximation of their phylogenetic relationships as shown in FIG. 51). In addition, some or all of the newly created classification codes may then be stored in the database as a reference life form code.

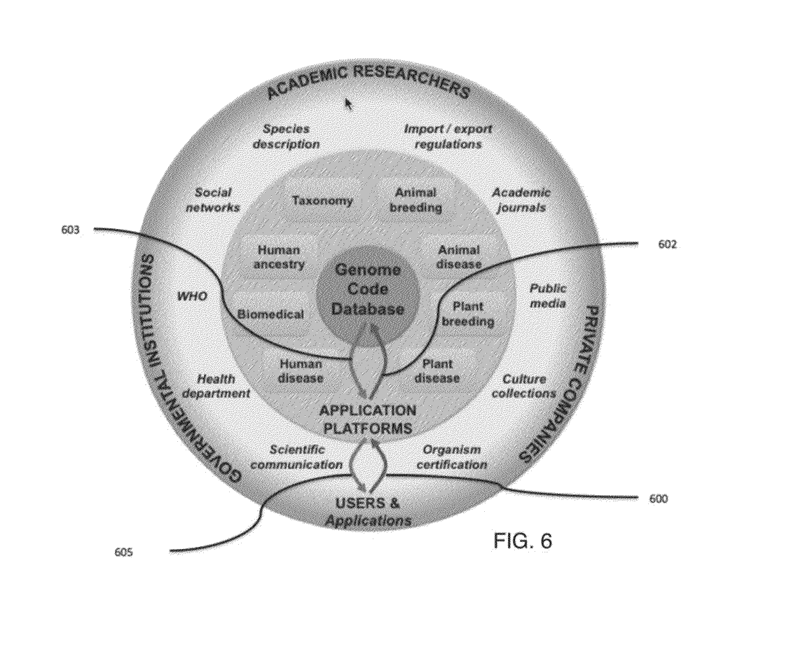

FIG. 6 shows one possible application of the genome similarity-based codes of the invention. A user desiring a code for an organism submits a nucleic acid or genome sequence to a platform associated with a specific application. Each application platform is adapted to submit genomes to a central code database for unique code assignment. Codes are returned to the application platform, in which codes could be stored instead of entire genome sequences. Each platform would also store application-specific metadata associated with each code while the central code database stores genomes and associated codes. Arrows 600 and 602 represent submissions and arrows 603 and 605 represent code assignments.

What is claimed is:

1. A method of assigning to a life form a classification code having a plurality of predetermined positions with each position corresponding to a threshold level of nucleic acid similarity to a reference life form having a nucleic acid sequence comprising the steps of:
selecting from a nucleic acid database a nucleic acid sequence of said reference life form having a classification code having a plurality of predetermined positions;
determining the similarity between said nucleic acid sequence of said life form and said nucleic acid sequence of said reference life form;
creating a code for said life form having a plurality of predetermined positions equal to the number of said plurality of predetermined positions of said reference life form by performing a code assignment comprising the following steps:
for each predetermined position of the code of said life form, assign the same code value used in corresponding said position of said code of said reference life form when the similarity between the two nucleic acid sequences of the two said life forms is equal to or higher than the degree of similarity at said threshold level of nucleic acid similarity of said predetermined position;
repeating the above step until reaching a cutoff position in the code for which the similarity between said nucleic acid sequence of said life form and said reference nucleic acid sequence of said reference life form is lower than the threshold level of nucleic acid similarity at said cutoff position; and
at said cutoff position assigning a different code value to that position.

2. The method of claim 1 further including assigning to a first code having a default value at each predetermined position.

3. The method of claim 2 further including assigning after said cutoff position assigning the default value for each individual position.

4. The method of claim 1 further including assigning at said cutoff position of the code when said threshold is not exceeded a unique code value at said position that is different than the code value assigned to all other life forms that have already been assigned a classification code.

5. The method of claim 1 wherein said thresholds at said predetermined code positions have either a decreasing or increasing level of similarity going from one end of the code to the other.

6. The method of claim 1 wherein said reference nucleic acid sequence is the one with the greatest similarity to the nucleic acid sequence of said life form compared to all other life forms that were already assigned a classification code.

7. The method of claim 1 wherein a processor is used to compute the classification code.

8. The method of claim 1 wherein a database is used to store the nucleic acid sequences corresponding to the reference life forms.

9. The method of claim 8 wherein the created classification code is stored in said database as a reference life form code.

10. The method of claim 1 wherein the life form is a virus, bacterium, fungus, plant, animal, and human being and any mutated tissue or cell that is part of any such life form.

11. The method of claim 1 wherein thresholds range in degree of similarity from 70 percent to 99.999 percent.

12. The method of claim 1 wherein there are five predetermined positions.

13. The method of claim 1 wherein there are twenty-four predetermined positions.
